(19) United States
(12) Patent Application Publication
(10) Pub. No.: US 2017/0249808 A1
(43) Pub. Date: Aug. 31, 2017

(54) Anti-skimming Device

(71) Applicant: Markase Raymond, (US)

(72) Inventor: Raymond Markase, Gretna, LA (US)

(21) Appl. No.: 15/055,544

(22) Filed: Feb. 27, 2016

(51) Int. Cl. G07F 19/00

(52) U.S. Cl. CPC G07F 19/2055

(57) ABSTRACT

Automatic Teller Machines (ATMs) allow banking customers to conveniently make certain financial transactions. Typically, customers access ATMs through the use of an electronically encoded ATM-card with a magnetic strip or microchip that encodes customer account information. As a security measure, accessing a bank account at an ATM typically requires a personal identification number (PIN) that must be entered into the ATM key pad in order to initiate a transaction. Electronic devices, known as skimming devices, are capable of collecting bank account and PIN information unbeknownst to ATM customers. Skimming devices are applied onto, near or over an ATM card readers, and are often indistinguishable from the ATM card reader. When an ATM user attempts to access their bank account, the skimming devices record their bank account and PIN information. Armed with the bank account and PIN information, thieves are able to illegally access customer accounts and defraud banks. The anti-skimming device of the present invention offers an elegant approach to prevent illegal access to sensitive customer account information. Applying the anti-skimming device of the instant invention functions to ATMs helps to prevent illegal collection of account and PIN information from unsuspecting bank customers.

### CROSS-REFERENCE RELATED APPLICATIONS

Not applicable.

### STATEMENT REGARDING FEDERALLY SPONSORED RESEARCH AND DEVELOPMENT

Not applicable.

### REFERENCE TO SEQUENCE LISTING APPENDIX

Not applicable.

### BACKGROUND OF INVENTION

Skimming devices are electronic devices, surreptitiously applied to automatic tell machines (ATMs) by criminals attempting to illegally collect bank account and personal identification numbers (PIN) information. Armed with the bank account and PIN information, criminals can illegally access individual bank accounts for a variety of nefarious purposes, such as theft and bank fraud. Skimming devices are often indistinguishable from the ATM card-readers, and when customers, attempting to conduct a transaction at an ATM, inserts their ATM card, and enters their PIN, the information is collected by skimming devices for later, illegal use. Theft and bank fraud resulting from the use of skimming devices is estimated to cost the financial industry in excess of $1 billion dollars annually.

### FIELD OF THE INVENTION/TEHCNICAL FIELD

The disclosure herein relates to a specific field of anti-fraud devices, anti-skimming devices, that protect bank account and PIN information of customers conducting financial transactions at automatic teller machines. Specifically, the invention disclosed herein is an anti-skimming device and method for deploying said anti-skimming device to prevent illegal collection of customer account and PIN information through the use of skimming devices.

### RELATED ART OF THE INVENTION

Prior art attempts to prevent the nefarious machinations of criminals employing skimming devices rely on complicated software related solutions. For example, some solutions require specialized sensors or sophisticated image analysis solutions to recognize when skimming devices are applied to ATMs. While the success of these attempts is a matter of debate, there is no doubt that implementing and managing these such solutions are cost prohibitive, especially for smaller financial institutions operating ATMs.

U.S. Pat. No. 8,523,072 discloses a specialized ATM card reader that comprises multiple sensors that detect the application and/or presence of skimming devices. To employ this type of card reader the entire card reading assembly of an existing ATM has to be replaced with a specialized unit comprising a specialized sensor assembly. Moreover, these sensors need to be connected to a special computer monitoring system to allow active monitoring of the newly installed ATM card reader equipped with the sophisticated sensor assembly.

An even more sophisticated and complicated device is disclosed in U.S. Pat. No. 8,584,947, which discloses a specialized ATM and method for producing an electrical signal capable of “jamming” the ability of a skimming device to capture ATM user account and PIN information. Upon detection of the ATM cards by the disclosed ATM card-reader, an electrical signal is generated to block collection of bank account and PIN information by skimming devices.

These prior art attempts to prevent ATM skimming all require replacing exiting ATMs or retrofitting existing ATMs. The cost associated with replacing or retrofitting ATMs is non-trivial. Moreover, these solutions require some level of active, computerized monitoring that increases the cost of maintaining ATMs equipped with such solutions.

### DESCRIPTION OF THE FIGURES

FIG. 1 is a front view of the anti-skimming device.

FIG. 2 is a rear view of the anti-skimming device.

FIG. 3 is a bottom view of the anti-skimming device with the rear of the anti-skimming device facing upwards.

FIG. 4 is a bottom view of the anti-skimming device with the front of the anti-skimming device facing upwards.

FIG. 5 is a side view of the anti-skimming device.

FIG. 6 illustrates a general method for deploying the anti-skimming device.

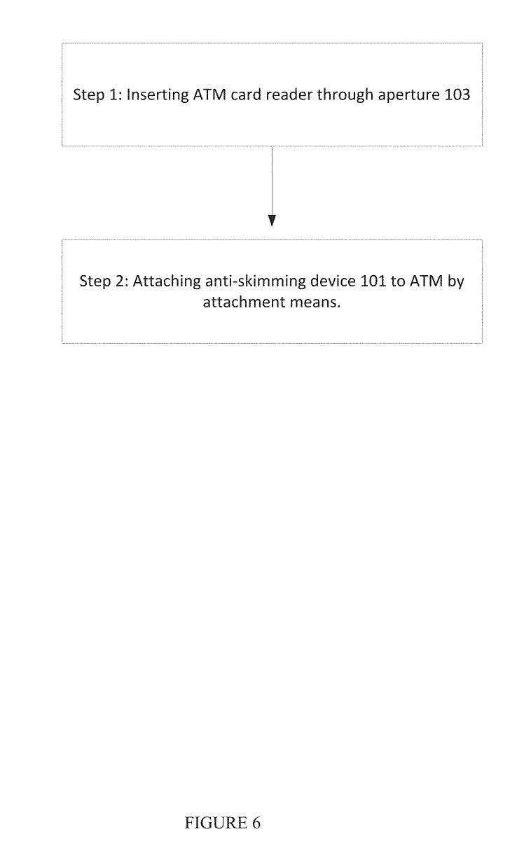

### SUMMARY

The anti-skimming device 101 disclosed herein provides an elegant, cost-effective means for deterring illegal collection of customer bank account and PIN information through the use of skimming devices attached to ATMs. According to the method for using the anti-skimming device 101 as disclosed herein, the anti-skimming device may be quickly and economically produced and affixed to any number of existing ATM devices to prevent the physical attachment of a skimming device to an ATM card reader.

### DETAILED DESCRIPTION OF THE INVENTION

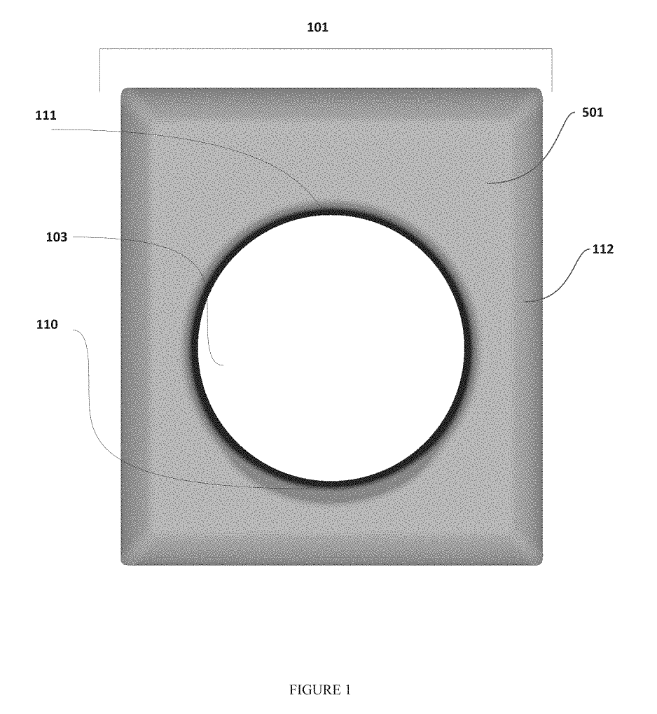

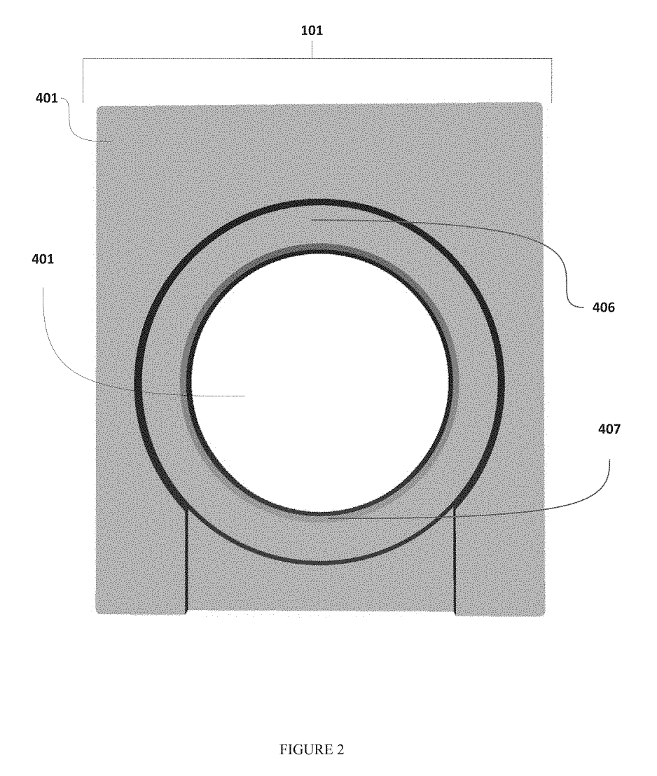

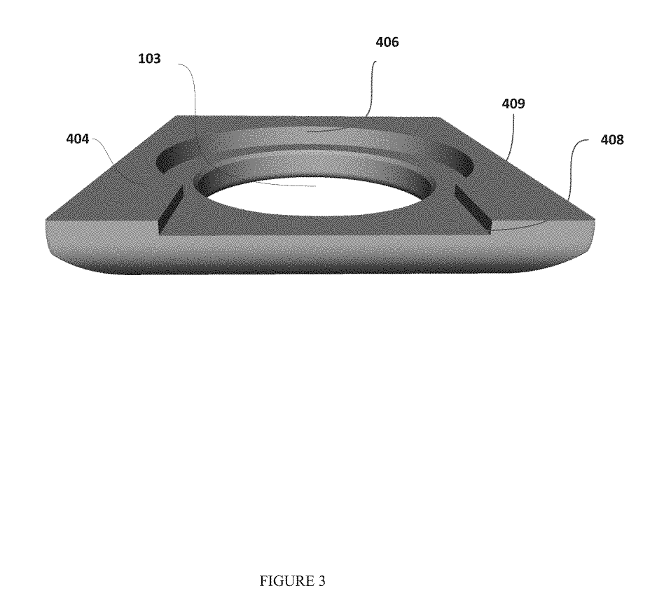

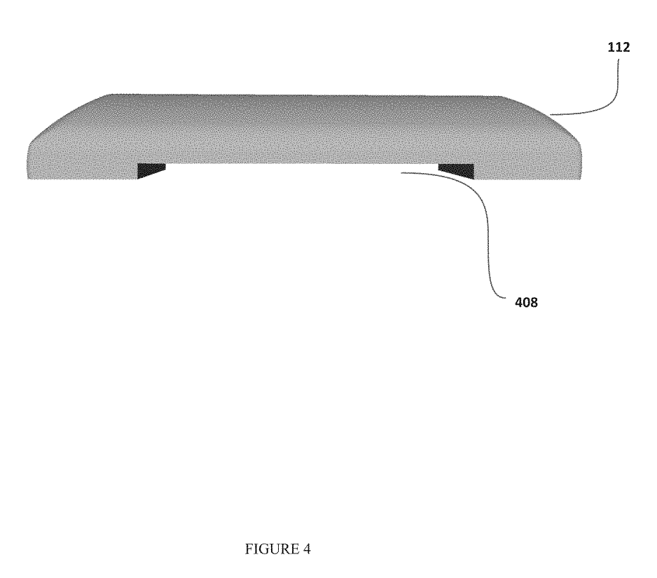

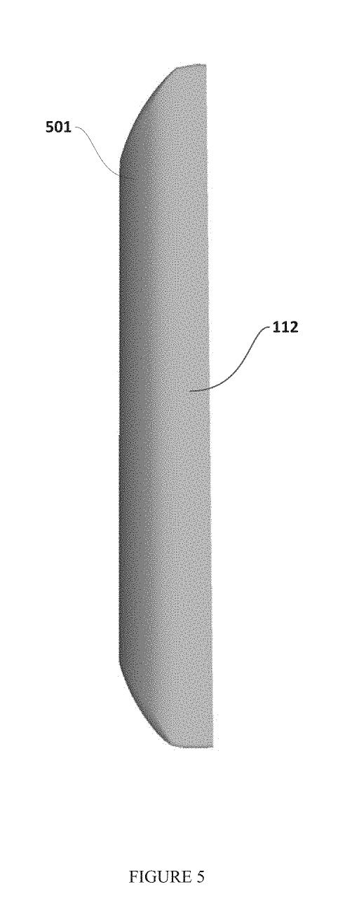

The anti-skimming device 101, as depicted in FIGS. 1-5, functions as a physical barrier preventing the attachment of skimming devices to ATMs when the anti-skimming device 1 is attached to an ATM. In one embodiment, the anti-skimming device 101 is positioned and attached to an ATM machine. More specifically, the anti-skimming device 101 is attached to the ATM such that the anti-skimming device is positioned around the card reader of the ATM via the reader aperture 103. The anti-skimming device 101 is (a) composed of a material that is sufficiently resistant to removal; and, (b) physically blocks the attachment of skimming devices. In one embodiment, the anti-skimming device 101 is comprised of steel. Yet, in other embodiments the anti-skimming device 101 may comprise the following materials: aluminum, titanium, iron, bronze, polycarbonate, polymers, or vinyl.

The anti-skimming device 101 is connected to the ATM, by physical affixing the anti-skimming device 101 to the ATM. For example, the anti-skimming device 101 may be attached to an ATM by drilling through an ATM door or cover and screwing the anti-skimming device 101 into place.

In one embodiment, the anti-skimming device 101 should have a width, height and thickness to sufficiently cover the ATM card reader and prevent the attachment of a skimming device. The width of the anti-skimming device 101 may range from approximately 2-8 inches, and is preferably about 4-6 inches in width. The height of the anti-skimming device 101 may range from 2-6 inches, and is preferably about 5-7 inches. The thickness of the anti-skimming device 101 may range from about 0.25 to 2 inches, and is preferably about 0.25 to 0.5 inches.

In one embodiment, the anti-skimming device 101 is square-shaped. In alternative embodiments, however, the shape of the anti-skimming device 101 may be triangular, circular, rectangular or oval.

In one embodiment, the anti-skimming device 101 comprises multiple features including: a back surface 401, a card reader aperture 403, and a front surface 501. In one embodiment, the back surface 401 is positioned against the ATM surface and attached to the ATM by an attachment means. In one embodiment, the back surface 401 comprises a back recess 406, and a feature bevel 407, respectively.

The back recess 406 of the anti-skimming device 101 comprises a configurable shape which allows positioning of the anti-skimming device 101 on a plurality of ATMs regardless of the manufacturer or model. In one embodiment, the back recess 406 is arranged on the back of the anti-skimming device 101 and adjacent to elements of the ATM machine.

One function of the back recess 406 is to seat the anti-skimming device onto the card reader. Moreover, the back recess may also be configured to mold to the particular elements of an individual ATM. Embodiments of a back recess 406 may include a depression, a cut out, a groove or the like. In one embodiment, it is reasonable to contemplate that if a back recess 406 is missing, then a separate piece or adaptor that allows the anti-skimming device 101 to be configured and properly attached to the ATM. In one embodiment, a back recess 406 may range from about 1 inch to about 6 inches, and more preferably is about 3 inches to about 5 inches. In one embodiment of the invention, the back recess 406 is shaped like a circle. In other embodiments of the invention, the back recess 406 may, in the alternative, be triangular, rectangular, circular or oval in shape.

In one embodiment, the back recess 406 comprises a back recess bottom surface 408, and a back recess side surface 409, respectively. The back recess bottom surface 408 comprises a recessed portion of the device configured to elements of the ATM machine with which it interacts. The back recess bottom surface 408 is preferably arranged parallel to the back surface 404 and adjacent to the reader aperture 103. The back recess bottom surface 408 allows the proper seating of the anti-skimming device 101 to one or more regions of an ATM. The back recess bottom surface 408 may have a width from about 0.25 inches to about 3 inches and more preferably from about 0.5 inches to 1 inch.

The back recess side surface 409 comprises a surface of the recessed portion of the device configured to accommodate elements of the ATM machine with which it interacts so that a flush attachment is made between the anti-skimming device 101 and the ATM device. In one embodiment, the back recess side surface 409 is arranged perpendicular to the back surface 404. One aim of the back recess side surface 409 is to adapt to one or more regions of the card reader regions of an ATM in concert with the back recess bottom surface 408. The back recess side surface 409 has a depth ranging from about 0.0875 inches to about 1 inch, and more preferably from about 0.1 inches to about 0.2 inches.

The feature bevel 407 comprises a component of the anti-skimming device 101 that functions to adapt the anti-skimming device 101 to one or more portions of the ATM. In one embodiment, the feature bevel 407 is arranged below the back recess 406. In another embodiment, the feature bevel 407 is designed to accommodate specific machine features. However, multiple other bevels, grooves, cut-outs or the like may be envisioned by a person of ordinary skill in the art in order to accommodate specific ATM features. For example, the feature bevel 407 may accommodate the machine design comprising an audio headphone jack and volume button to assist with the hearing impaired.

If the feature bevel 407 is missing in an alternative embodiment, then an adaptor may be used to accommodate the ATM features and allow the anti-skimming device 101 to be properly seated on the ATM device. In other instances, if the feature bevel 407 is absent then the back recess 406 may be used alone.

When present, the feature bevel 407 has a width ranging from about 0.1 inches to about 10 inches, and more preferably from about 0.2 inches to about 1 inch. In one embodiment, the feature bevel 407 is rectangular in shape. In alternative embodiments, the feature bevel 407 may be triangular, square, or oval.

The reader aperture 103 is the opening through the anti-skimming device 101 where a user of an ATM card reader is accessed by a user. The ATM user may insert their card through the reader aperture 103 into the card read of the ATM. Spatially, the reader aperture 103 may be situated in the center of the anti-skimming device 101, yet, in alternative embodiments, the reader aperture 103 may be located in any position of the anti-skimming device 101. The diameter of the reader aperture may range from about 1 inch to about 4 inches, and more preferably is about 2.5 to about 3.5 inches. The reader aperture 103 may be circular, or alternatively shaped (e.g., square, rectangle, or triangle).

The reader aperture 103 may also comprises a bottom aperture edge 110, and a top aperture edge 111. The bottom aperture edge 110 may comprise a beveled edge to accommodate features of the card reader.

A front surface 501 preferably faces customers. Further, the front surface 501 preferably comprises an additional sub-item called the beveled edge 112. The beveled edge 112 is arranged on the outside edge of the anti-skimming device 101. The beveled edge 112 provides superior tactile interaction with customer hands and reduces sharp edges that may cause damage to customer hands. Moreover, the beveled edge 112 is aesthetically pleasing to customers. In lieu of a beveled edge 112, alternative embodiments may have no ornamental or functional edge.

An attachment means comprises any means by which an anti-skimming device 101 may be attached to an ATM machine. The attachment means may be arranged between the ATM machine and the anti-skimming device 101. The attachment means functions to attach the anti-skimming device 101 to the ATM; or adhere the protection device to the ATM; so as to physically block attachment of skimming devices to ATM card readers.

The attachment means attaches the anti-skimming device 101 to the ATM. In one embodiment, the attachment means may attach the anti-skimming device 101 to the ATM by drilling through an ATM cover, and affixing the anti-skimming device 101 to the ATM using screws. In other embodiments, examples of an attachment means may include screws, glue, bolts, molly bolt, a template to guide drilling holes into machine cover, a lock wherein the anti-skimming device may be inserted, or the like. At least one attachment means is required to affix the anti-skimming device to the ATM, and preferable more than one attachment means is employed. In the one exemplary embodiment, the attachment means comprise four screws that are drilled through the ATM frame or body and into the anti-skimming device to affix the anti-skimming device 101 to the ATM.

In an exemplary embodiment, a method of the invention disclosed herein comprises preventing collection of customer account and PIN information through the use of skimming devices by (a) attaching an anti-skimming device 101 to an ATM.

A method for using the invention described herein involves the following steps: (i) creating an anti-skimming device 101, wherein the anti-skimming device 101 may be produced by means of machining and fabrication, 3D printing, injection molding and/or casting; (ii) attaching the skimming device 101 to at least one ATM, wherein an attachment means is employed and said attachment means may comprise screws, glue, bolts, molly bolt, a template to guide drilling holes into machine cover, a lock wherein the anti-skimming device may be inserted; and, (iii) preventing the attachment of a skimming device to the ATM, wherein the attachment means may comprise screws, glue, blots, molly bolts, a guide template for inserting an attachment into an ATM, or a lock.

In further detail: Step (ii) of the method disclosed above may have an additional step such as: inserting one or more portions of the ATM card reader through a reader aperture 103. While the steps of the above method are depicted in an order, it is thought that these steps may be performed in one or more alternative orders and still reflect the novelty of the invention.

An exemplary embodiment of the present invention is set forth in the referenced figures. Also in the figures. While specific configurations and arrangements are discussed, it should be understood that this is done for illustrative purposes only. A person of ordinary skill in the relevant art will recognize that other configurations and arrangements may be used without departing from the spirit and scope of the invention. It will be apparent to a person of ordinary skill in the relevant art that this invention can also be employed in a variety of other systems and applications.

We claim:

1. An anti-skimming device comprising:
a. a material that is resistant to removal;
b. a specific shape; and,
c. a specific set of dimensions;
wherein, the shape an dimension of the device sufficiently cover the ATM card reader; and,
wherein, the device prevents the collection of customer bank account and PIN information.

2. An anti-skimming device of claim 1, further comprising:
a. a front surface;
b. a back surface; and,
c. a card reader aperture.

3. An anti-skimming device of claim 2, wherein the back surface comprises at least one recessed area to allow the device to be properly seated on the ATM.

4. An anti-skimming device of claim 1, comprising a means for attaching the anti-skimming device to an ATM.

5. An anti-skimming device of claim 4, wherein the means for attaching the anti-skimming device further comprises screws, glue, blots, molly bolts, or a lock

6. An anti-skimming device of claim 5, further comprising a guide template for inserting an attachment means into an ATM.

7. A method for preventing or reducing collection of account information at an ATM comprising:
a. producing an anti-skimming device;
b. attaching an anti-skimming device to an ATM.

8. A method of claim 7, wherein said anti-skimming device functions to prevent attachment of skimming devices to ATMs.
